(19) United States
(12) Patent Application Publication
(10) Pub. No.: US 2022/0417927 A1
(43) Pub. Date: Dec. 29, 2022

(54) TIRE PRESSURE DETECTION SYSTEM WITH SINGLE ANTENNA

(71) Applicant: SHIH-CHIN CHO, TAIPEI CITY (TW)

(72) Inventor: SHIH-CHIN CHO, TAIPEI CITY (TW)

(21) Appl. No.: 17/361,335

(22) Filed: Jun. 29, 2021

(51) Int. Cl. H04W 72/04; H04W 4/80; H04W 4/38; B60C 23/04

(52) U.S. Cl. CPC H04W 72/0453; H04W 4/80; H04W 4/38; B60C 23/0444

(57) ABSTRACT

A tire pressure detection system with single antenna includes a detection end 10 and a receiving end. The detection end includes tire pressure detectors to detect the tire to obtain the tire status. The tire pressure detectors outputs the tire status, and the information of the tire status is output in the form of radio frequency signal and Bluetooth signal to the tire-pressure receiving device, the audio-video device and the mobile device so that the users are acknowledged about the information of the tire including tire pressure and tire temperature.

### BACKGROUND OF THE INVENTION

### 1. Fields of the Invention

The present invention relates to a tire pressure detection system, and more particularly, to a tire pressure detection system with single antenna, and the information of the tire status is sent to a remote receiving device.

### 2. Descriptions of Related Art

The present invention relates to a tire pressure detection system, and more particularly, to a tire pressure detection system that sends information of the tire pressure to a remote receiving device.

The conventional tire pressure detector only has a single wireless signal transmission mode in the form of radio frequency signal or Bluetooth signal. The signals of the detected tire are sent to a receiving device on the vehicle so that the users is acknowledged about the pressure and temperature information of the tire.

When the users want to use car audio-visual devices or mobile devices (car audio-video devices and mobile devices hereinafter referred to as external devices) as a reading/displaying device for displaying the tire information. However, because the detected signals are different, so that a signal receiving converter is required to be installed in the car. The signal receiving converter not only occupies a certain space in the car, but also requires additional power supply which usually occupies the cigarette lighter power supply socket or power socket, which has its problems to be overcome.

The present invention intends to provide a tire pressure detection system with single antenna to eliminate shortcomings mentioned above.

### SUMMARY OF THE INVENTION

The present invention relates to a tire pressure detection system with single antenna, and comprises a detection end and a receiving end. The detection end includes multiple tire pressure detectors. The receiving end includes a tire-pressure receiving device, an audio-video device and a mobile device. Each of the tire pressure detectors includes a tire status detection unit, a main control unit, a switch unit, an antenna unit, a radio frequency circuit and a Bluetooth circuit.

The main control unit is electrically connected to the tire status detection unit, the radio frequency circuit and the Bluetooth circuit. The switch unit is electrically connected to the main control unit and the antenna unit. The tire status detection unit continuously detects the tire status. The main control unit transfers the information of the tire status into a control transferring signal, and the main control unit sends the control transferring signal out.

The radio frequency circuit includes a radio frequency control unit, a radio frequency matching unit which is electrically connected with the radio frequency control unit and the switch unit. The radio frequency control unit receives the control transferring signal and transfers the control transferring signal into a radio frequency single. The radio frequency matching unit adjusts the control transferring signal into a pre-set radio frequency impedance matching.

The Bluetooth circuit includes a Bluetooth control unit, a Bluetooth matching unit. The Bluetooth matching unit is electrically connected to the Bluetooth control unit and the switch unit. The Bluetooth control unit receives the control transferring signal and transfers the control transferring signal into Bluetooth signal. The Bluetooth matching unit transfers the control transferring signal into a pre-set Bluetooth impedance matching.

The main control unit demands the switch unit to switch the antenna unit into a corresponding frequency band according to the frequency signal or Bluetooth signal. The frequency signal or Bluetooth signal individually and simultaneously are output to any one or more than two of the tire-pressure receiving device, the audio-video device and the mobile device to display the tire status.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates the block diagram of the tire pressure detection system with single antenna of the present invention;

FIG. 2 illustrates the block diagram of the tire pressure detector, the tire-pressure receiving device, the audio-video device and the mobile device;

FIG. 3 illustrates that the tire pressure detector wirelessly sends transferring signals to the tire-pressure receiving device, the audio-video device and the mobile device;

FIG. 4 illustrates a block diagram of the tire pressure detector of the present invention;

FIG. 5 shows that the tire-pressure receiving device and the audio-video device receive the tire status from the tire pressure detector, and

FIG. 6 shows the steps of the tire pressure detection system with single antenna of the present invention.

### DETAILED DESCRIPTION OF THE PREFERRED EMBODIMENT

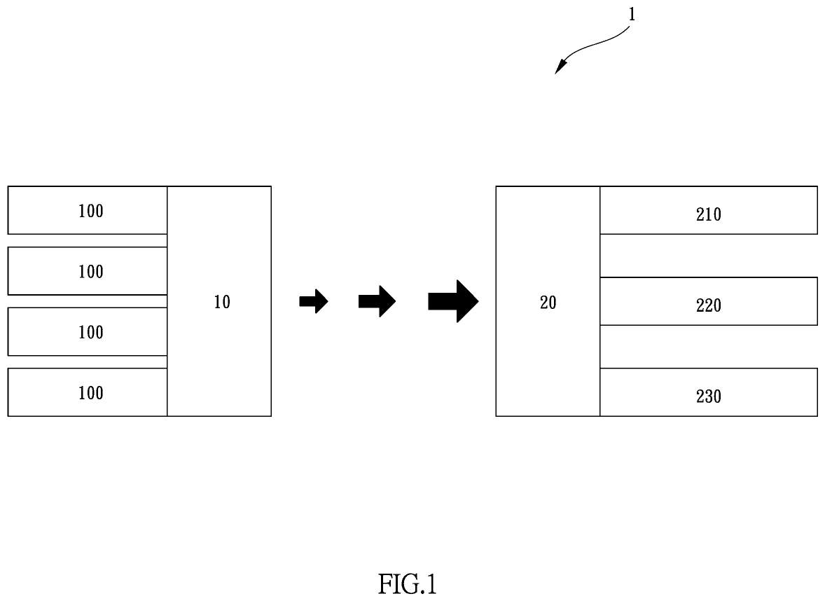

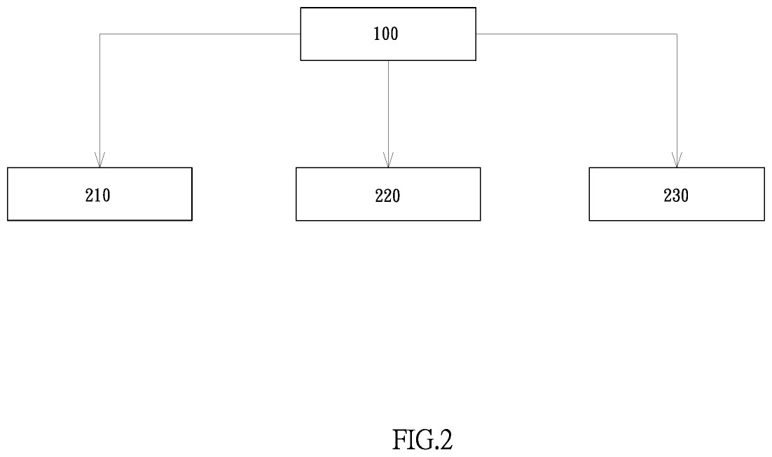

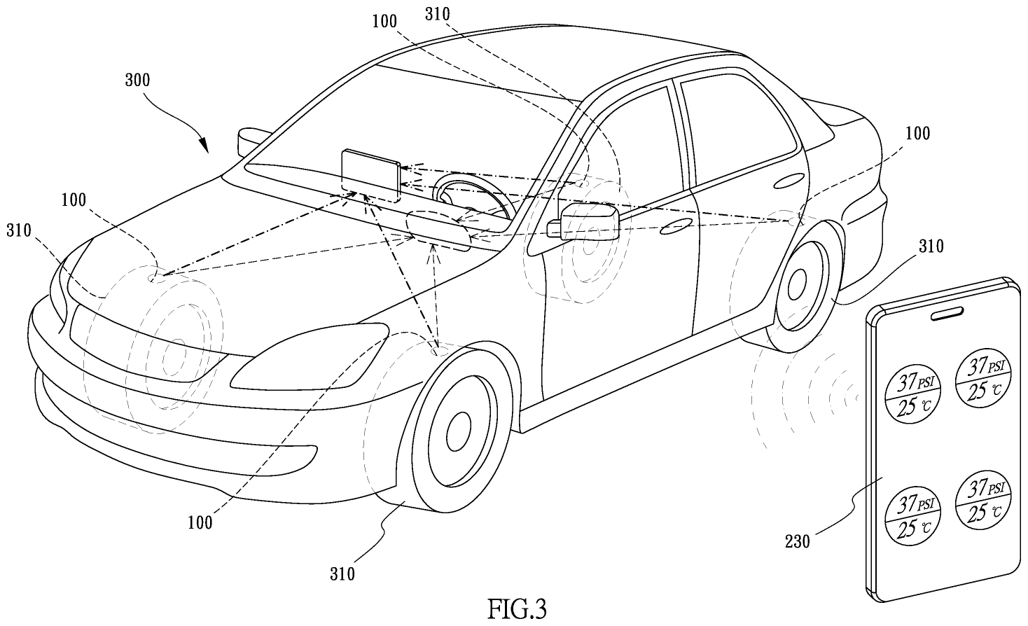

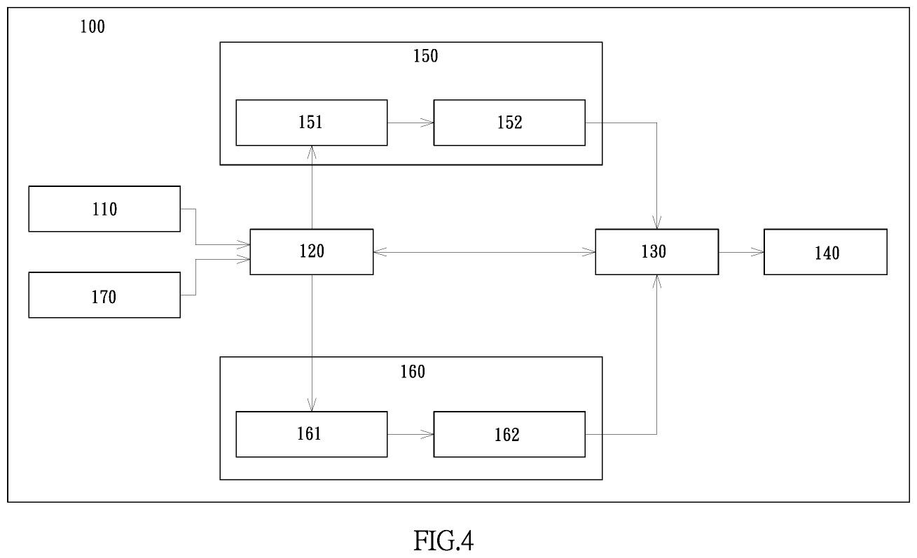

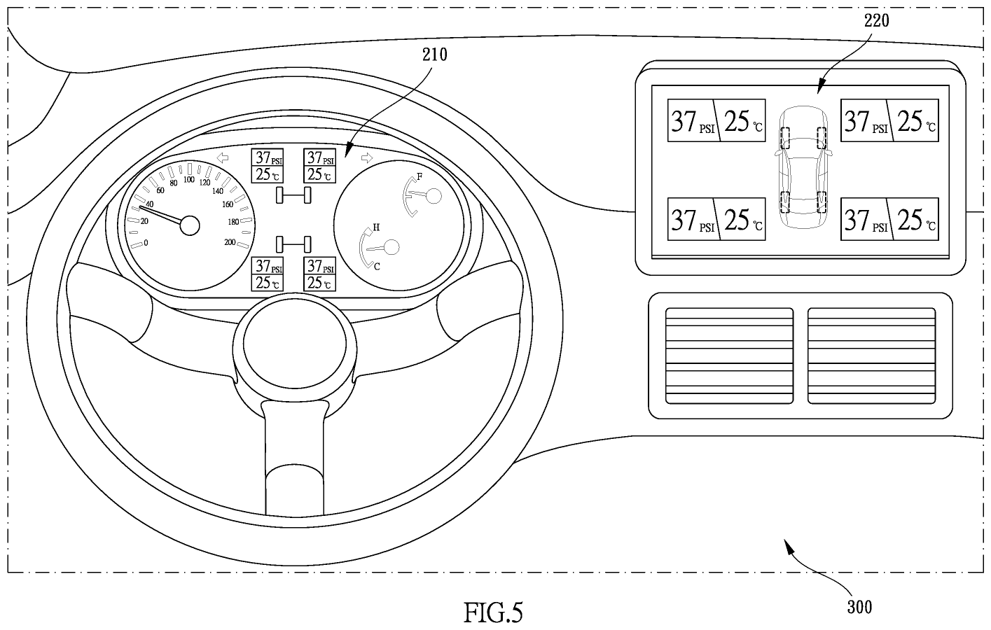

Referring to FIGS. 1 to 5, the tire pressure detection system with single antenna of the present invention comprises a detection end 10 and a receiving end 20. The detection end 10 including multiple tire pressure detectors 100. In this embodiment, there are four tire pressure detectors 100 respectively installed to four tires 310 of a vehicle 300. The receiving end 20 includes a tire-pressure receiving device 210, an audio-video device 220 and a mobile device 230. The tire-pressure receiving device 210 is built in the vehicle 30 by the manufacturers. The audio-video device 220 can be a built-in equipment or an externally installed device. The mobile device 230 can be the users' small phones.

Each of the tire pressure detectors 100 includes a tire status detection unit 110, a main control unit 120, a switch unit 130, an antenna unit 140, a radio frequency circuit 150 and a Bluetooth circuit 160.

The main control unit 120 is electrically connected to the tire status detection unit 110, the radio frequency circuit 150 and the Bluetooth circuit 160. The switch unit 130 is electrically connected to the main control unit 120 and the antenna unit 140. The tire status detection unit 110 continuously detects the tire status, and the main control unit 120 transfers the information of the tire status into a control transferring signal. The main control unit 120 sends the control transferring signal out.

The radio frequency circuit 150 includes a radio frequency control unit 151 and a radio frequency matching unit 152. The radio frequency matching unit 152 is electrically connected with the radio frequency control unit 151 and the switch unit 130. The radio frequency control unit 151 receives the control transferring signal and transfers the control transferring signal into a radio frequency single. The radio frequency matching unit 152 adjusts the control transferring signal into a pre-set radio frequency impedance matching.

The Bluetooth circuit 160 includes a Bluetooth control unit 161, a Bluetooth matching unit 162. The Bluetooth matching unit 162 is electrically connected to the Bluetooth control unit 161 and the switch unit 130. The Bluetooth control unit 161 receives the control transferring signal and transfers the control transferring signal into a Bluetooth signal. The Bluetooth matching unit 162 transfers the control transferring signal into a pre-set Bluetooth impedance matching.

The main control unit 120 demands the switch unit 130 to switch the antenna unit 140 into a corresponding frequency band according to the frequency signal or the Bluetooth signal. The frequency signal and the Bluetooth signal individually or simultaneously are output to any one or more than two of the tire-pressure receiving device 210, the audio-video device 220 and the mobile device 230 to display the tire status.

When in use, the detection end 10 detects the tire status of the tire 310, such as the tire pressure and the tire interior temperature, by the tire status detection unit 110 of the tire pressure detector 100. The main control unit 120 sends the detected information to the receiving end 20 in the form of radio frequency signal and Bluetooth signal by radio frequency circuit 150 and the Bluetooth circuit 160. The main control unit 120 demands the switch unit 130 to switch the antenna unit 140 into a corresponding frequency band according to the frequency signal or the Bluetooth signal. The frequency signal and the Bluetooth signal are individually or simultaneously output to any one or more than two of the tire-pressure receiving device 210, the audio-video device 220 and the mobile device 230 to display the tire status.

The tire pressure detector 100 provides two types of signals which are the radio frequency signal and the Bluetooth signal, to not only the tire-pressure built-in receiving device 210, also the tire status cab display on the audio-video device 220 and the mobile device 230 without extra signal converters so as to improve the problems of the conventional tire pressure detector system.

It is noted that the radio frequency signal is a 315 MHz and 433.92 MHz transferring signal, and the Bluetooth signal is a 2.4 GHz transferring signal.

The main control unit 120 sends the control transferring signal to the radio frequency control unit 151 and the Bluetooth control unit 161 by any one or more than two of a pre-set sequence, a pre-set number of times and a pre-set of time.

Each of the tire pressure detectors 100 includes a calling unit 170 which is electrically connected to the main control unit 120.

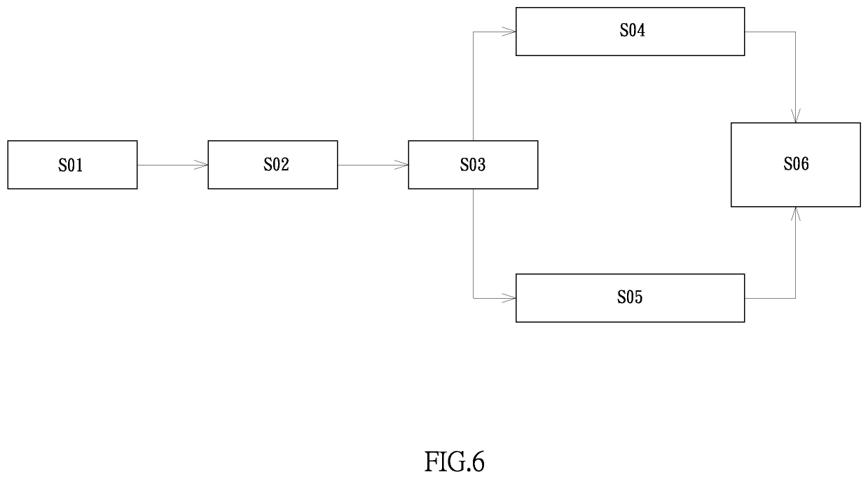

FIG. 6 shows the operation of the tire pressure detection system with single antenna 1 of the present invention, and includes the following steps:

Step S01: the calling unit 170 of the tire pressure detector 100 is activated from hibernation mode into monitoring mode by way of induction by vibration or eccentric action;

Step S02: after the tire detection detector 100 is activated, the main control unit 120 demands the tire status detection unit 110 to continuously detect the tire pressure and the interior temperature of the tire 310 so as to obtain information of the tire status, and the information of the tire status is transferred into control transferring signal and sent out;

Step S03: the main control unit 120 sends the control transferring signal to the radio frequency control unit 151 and the Bluetooth control unit 161 by two of a pre-set sequence, a pre-set number of times and a pre-set of time;

Step S04: when the signal sent out is a radio frequency signal, the radio frequency control unit 151 receives the control transferring signal and transfers the control transferring signal into a radio frequency single, and the radio frequency matching unit 152 adjusts the control transferring signal into a pre-set radio frequency impedance matching so as to obtain a maximum rate of work transferring;

Step 05: when the signal sent out is a Bluetooth signal, the Bluetooth control unit 161 receives the control transferring signal and transfers the control transferring signal into Bluetooth signal, the Bluetooth matching unit 162 transfers the control transferring signal into a pre-set Bluetooth impedance matching so as to obtain a maximum rate of work transferring, and

Step 06: after the main control unit 120 demands the switch unit 130 to switch the antenna unit 140 into a corresponding frequency band according to the frequency signal or the Bluetooth signal, the frequency signal or the Bluetooth single is sent to any one or more than two of the tire-pressure receiving device 210, the audio-video device 220 and the mobile device 230 to display the tire status.

While we have shown and described the embodiment in accordance with the present invention, it should be clear to those skilled in the art that further embodiments may be made without departing from the scope of the present invention.

What is claimed is:

1. A tire pressure detection system with single antenna comprising:
a detection end and a receiving end, the detection end including multiple tire pressure detectors, the receiving end including a tire-pressure receiving device, an audio-video device and a mobile device;
each of the tire pressure detectors including a tire status detection unit, a main control unit, a switch unit, an antenna unit, a radio frequency circuit and a Bluetooth circuit;
the main control unit electrically connected to the tire status detection unit, the radio frequency circuit and the Bluetooth circuit, the switch unit electrically connected to the main control unit and the antenna unit, the tire status detection unit continuously detecting a tire status, the main control unit transferring an information of the tire status into a control transferring signal, the main control unit sending the control transferring signal out;
the radio frequency circuit including a radio frequency control unit and a radio frequency matching unit, the radio frequency matching unit electrically connected with the radio frequency control unit and the switch unit, the radio frequency control unit receiving the control transferring signal and transferring the control transferring signal into a radio frequency single, the radio frequency matching unit adjusting the control transferring signal into a pre-set radio frequency impedance matching;
the Bluetooth circuit including a Bluetooth control unit, a Bluetooth matching unit, the Bluetooth matching unit electrically connected to the Bluetooth control unit and the switch unit, the Bluetooth control unit receiving the control transferring signal and transferring the control transferring signal into Bluetooth signal, the Bluetooth matching unit transferring the control transferring signal into a pre-set Bluetooth impedance matching, and
the main control unit demanding the switch unit to switch the antenna unit into a corresponding frequency band according to the frequency signal or the Bluetooth signal, the frequency signal and the Bluetooth signal individually or simultaneously being output to any one or more than two of the tire-pressure receiving device, the audio-video device and the mobile device to display the tire status.

2. The tire pressure detection system with single antenna as claimed in claim 1, wherein the radio frequency signal is a 315 MHz and 433.92 MHz transferring signal, the Bluetooth signal is a 2.4 GHz transferring signal, the tire status includes tire pressure and tire temperature.

3. The tire pressure detection system with single antenna as claimed in claim 1, wherein each of the tire pressure detectors includes a calling unit which is electrically connected to the main control unit.

4. The tire pressure detection system with single antenna as claimed in claim 1, wherein the main control unit sends the control transferring signal to the radio frequency control unit and the Bluetooth control unit by a pre-set sequence.

5. The tire pressure detection system with single antenna as claimed in claim 1, wherein the main control unit sends the control transferring signal to the radio frequency control unit and the Bluetooth control unit by a pre-set number of times.

6. The tire pressure detection system with single antenna as claimed in claim 1, wherein the main control unit sends the control transferring signal to the radio frequency control unit and the Bluetooth control unit by a pre-set of time.

7. The tire pressure detection system with single antenna as claimed in claim 1, wherein the main control unit sends the control transferring signal to the radio frequency control unit and the Bluetooth control unit by one of or two of a pre-set sequence, a pre-set number of times and a pre-set of time.
